(19) United States
(12) Patent Application Publication
(10) Pub. No.: US 2026/0005884 A1
(43) Pub. Date: Jan. 1, 2026

(54) PERIODIC UPDATE BASED 5G SESSION VALIDATION

(71) Applicant: Oracle International Corporation, Redwood City, CA (US)

(72) Inventors: Geeta Mohanty, Bengaluru (IN); Rajiv Krishan, Cary, NC (US); Uri Baniel, Buffalo Grove, IL (US)

(21) Appl. No.: 18/755,472

(22) Filed: Jun. 26, 2024

(51) Int. Cl. H04L 12/14; H04W 48/16

(52) U.S. Cl. CPC H04L 12/1407; H04W 48/16

(57) ABSTRACT

Various embodiments of the present technology generally relate to systems and methods for validating 5G sessions by providing periodic updates from a policy control function (PCF) to a binding support function (BSF). In certain embodiments, a PCF system may comprise one or more processors, and a memory having stored thereon instructions. The instructions, upon execution, may cause the one or more processors to send a binding record request to a Binding Support Function (BSF) for a 5G communication session associated with the PCF, receive a binding record confirmation with a selected revalidation time value that indicates when the 5G communication session will be considered invalid and a binding record associated with the 5G communication session will be deleted, and prior to an expiration of the selected revalidation time value, send a binding record update request to the BSF to refresh the selected revalidation time value.

### TECHNICAL FIELD

Various embodiments of the present technology generally relate to management of networks, such as fifth generation (5G) communications networks. More specifically, embodiments of the present technology relate to systems and methods for improved management of communication sessions within networks.

### BACKGROUND

In some communication network architectures, such as those using third generation partnership project (3GPP) standards, service may be implemented by establishing a user communication session, such as a UE (User Equipment) session or a PDU (packet data unit or protocol data unit) session. To support a voice or data call, a number of network functions (NFs) within a 5G network may work together to manage aspects of the session.

In an example process of establishing a communication session, user equipment (UE) may register with the network, and trigger (e.g., via a session management function, SMF) the creation of a PDU session in order to exchange data with the network. As part of the PDU session creation process, a policy control function (PCF) may be assigned to the session to generate policy rules for the session to control quality of service (QoS) and charging for the session. The PCF assigned to the session may register with a binding support function (BSF), and the BSF can create a binding record for the session in its database. The binding record can ensure that an application function (AF) request for a certain PDU session can reach the relevant policy PCF having the PDU session information for AF or Rx sessions associated with the PDU session. NF service consumers seeking to discover the PDU session binding for a UE may do so by querying the BSF using a discovery application programming interface (API) provided by the BSF. The BSF network function assigned to the session can comprise information such as N7 session parameters, N7 endpoint, and Diameter identity for a PCF instance, and a session linked to a function in this manner may be referred to as a binding session.

However, PDU sessions may constantly be created and ended, and the BSF may have no way to reliably determine whether a PDU session is still active and valid. For example, the BSF may be aware of a session's validity if Rx authorization authentication request (AAR) sessions from an AF to a PCF are successful. But if there are no Rx sessions established, there may be no procedure by which a BSF can periodically determine the validity of PDU sessions as per 3GPP technical specification (TS) 29.521. Thus, a BSF may not accurately detect and identify PCF bindings related to stale PDU sessions, which are not active in a PCF but are still active in the BSF. If stale binding records are not deleted or cleaned up, resources can be wasted, or other inefficiencies can occur. In some examples, there may be large numbers of stale bindings remaining within a BSF database. Keeping records of stale or invalid PDU sessions at a BSF may result in performance degradation and slowed processing for active calls.

In addition to the BSF storing a binding record of a PCF to a PDU session, 3GPP R17 added the ability for a BSF to store bindings of a PCF against a particular UE based on a Subscription Permanent Identifier (SUPI) for the UE. In this case, the PCF may be known in 3GPP as the ‘PCF for a UE’. For PCF to UE bindings, the BSF bindings have nothing to do with any PDU session, and may be referred to as a UE session. In particular, a PDU session may occur when an IP address is allocated to a UE, so that, for example, it will be able to browse the Internet or make VoIP calls. PCF storage of bindings at the BSF, which is related to the establishment of a PDU session is illustrated in 3GPP TS 29.513 5.2.1. Meanwhile, a UE session may occur when a UE has just been activated (e.g., when a phone is turned on). PCF storage of binding at the BSF, which is related to UE registration may be illustrated in 3GPP TS 29.513 5.1.1 or 3GPP TS 29.513 5.1.1 5.6.1. PCF binding at the BSF related to PDU sessions and UE sessions, respectively, may be managed similarly by the BSF, and share difficulties in being audited for validity by the BSF. Therefore, PDU and UE sessions may generally be referred to herein as “5G sessions” or “PDU/UE sessions.” Accordingly, there exists a need for improved 5G session validation operations.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for performing periodic update based 5G session validation. In an embodiment, a Policy Control Function (PCF) system may comprise one or more processors, and a memory having stored thereon instructions. The instructions, upon execution, may cause the one or more processors to send a binding record request to a Binding Support Function (BSF) for a 5G communication session associated with the PCF, receive a binding record confirmation with a selected revalidation time value that indicates when the 5G communication session will be considered invalid and a binding record associated with the 5G communication session will be deleted, and prior to an expiration of the selected revalidation time value, send a binding record update request to the BSF to refresh the selected revalidation time value.

In some embodiments, the PCF system may issue a discovery request to a network repository function (NRF) to discover one or more BSFs able to manage the binding record for the 5G communication session, receive one or more profiles associated with the one or more BSFs and select the BSF to send the binding record request based on a profile for the BSF indicating support for a revalidation time custom feature. The PCF system may include a proposed revalidation time value with the binding record request, determine whether the selected revalidation time value received from the BSF matches the proposed revalidation time value, and implement the selected revalidation time value when the proposed revalidation time value and the selected revalidation time value do not match. In some examples, the PCF system may send the binding record update request to indicate to the BSF to refresh the selected revalidation time value from the binding record confirmation, and refresh the selected revalidation time value at the PCF to determine when to send a next binding record update request. In other examples, the PCF system may include a refresh revalidation time in the binding record update request, the refresh revalidation time suggesting a new revalidation time value. The PCF system may receive a binding record update confirmation in response to the binding record update request, the binding record update confirmation including a selected refresh revalidation time, determine whether the selected refresh revalidation time received matches the new revalidation time value, and implement the selected refresh revalidation time when the new revalidation time value and the selected refresh revalidation time do not match. In some embodiments, the PCF system may determine when the 5G communication session is ended, and send a session termination message to the BSF based on the determination prior to expiration of a current revalidation time period. The PCF system may receive an Rx protocol message associated with the 5G communication session and routed through the BSF, and reset the selected revalidation time value based on receiving the Rx protocol message. In some examples, the 5G communication session comprises a packet data unit (PDU) session. In other examples, the 5G communication session comprises a user equipment (UE) session.

In an alternative embodiment, a method may comprise operating a Policy Control Function (PCF) of a mobile network, including sending a binding record request to a Binding Support Function (BSF) for a 5G communication session associated with the PCF, receiving a binding record confirmation with a selected revalidation time value that indicates when the 5G communication session will be considered invalid and a binding record associated with the 5G communication session will be deleted, and prior to an expiration of the selected revalidation time value, sending a binding record update request to the BSF to refresh the selected revalidation time value.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of a system configured to implement periodic update based 5G session validation, in accordance with certain embodiments of the present disclosure;

FIG. 2 depicts a flow diagram of an example method to perform periodic update based 5G session validation, in accordance with certain embodiments of the present disclosure;

FIG. 3 depicts a flowchart of an example method to perform periodic update based 5G session validation, in accordance with certain embodiments of the present disclosure;

FIG. 4 depicts a flowchart of an example method to perform periodic update based 5G session validation, in accordance with certain embodiments of the present disclosure; and

FIG. 5 is a diagram of a system configured to implement periodic update based 5G session validation, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

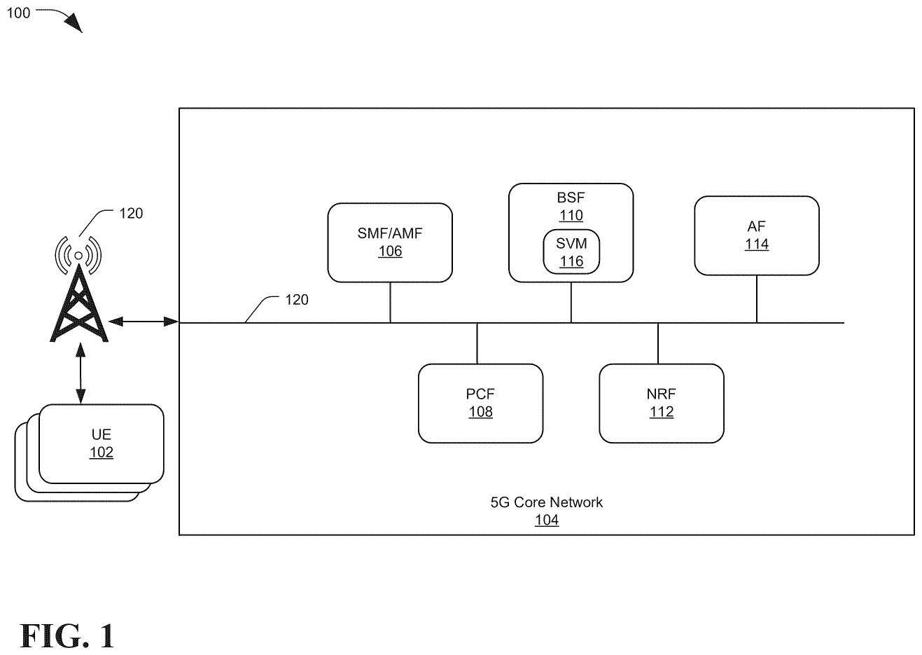

FIG. 1 is a diagram of a system 100 configured to implement periodic update based 5G session validation, in accordance with certain embodiments of the present disclosure. The example system 100 may include a mobile network implementing 3GPP (3rd Generation Partnership Project) communication standards (e.g., using the 29.521 TS), although the present disclosure may apply to other communication networks. In particular, the mobile network may include components and elements to implement a cellular network, such as a 5G Core (5GC or 5GS) network 104. The system 100 may include one or more user equipment (UE) 102 connected to 5G network 104 via network connectivity components 120.

Each or any of UE 102, 5G network 104 and its components, and network 120 may be implemented via computers, servers, hardware and software modules, or other system components. The components of 5G network 104, or the physical devices implementing them, may be co-located, remotely distributed, or any combination thereof. The elements of system 100 may include components hosted or situated in the cloud, implemented as software modules potentially distributed across one or more server devices or other physical components, or otherwise implemented.

UE 102 may be a device, system, or module that may utilize the resources of the 5G network 104, such as to establish communications with another UE. Communication sessions may include, but are not limited to, IMS calls (Internet Protocol Multimedia subsystem), other cell phone calls, internet or other data connections, UE registrations (as PCF 108 may register UE 102 bindings at the BSF 110 as part of this communication; see, e.g., 3GPP TS 29.513 5.1.1, 29.513 5.6.1, 23.502 4.16.1/.2/.11/.12), or any and all other types of communications sessions over 5G networks. UE 102 may include devices such as cell phones, tablets, modems, vehicles, desktop or laptop computers, televisions or set-top boxes, smart home devices, voice over IP (VoIP) devices, internet of things (IoT) devices, or any and all other systems that may utilize a cellular network.

Network connectivity components 120 may provide communication paths between UE 102 and 5G network 104. Network connectivity components 120 may comprise components that enable communication over communication links, such as network cards, ports, radio frequency (RF) modules, telecommunications channels, cell towers, switches, routers, processing circuitry and software, or other communication components. Network connectivity components 120 may include metallic, wireless, cellular, or optical links, using various communication formats and protocols. In some examples, network connectivity components 120 may simply be referred to as a “network” by which systems or modules are connected or communicate.

The 5G network 104 may comprise a mobile communications network that provides services to UEs 102 through the network connectivity components 120. 5G network 104 may include a plurality of components, modules, or network functions (NFs) configured to provide mobile communication services via the corresponding 5G Core communications protocols. Some components of 5G network 104 may be configured to communicate and operate with other networks, such as 4G networks, networks controlled by other network operators, or other network environments. 5G core network 104 may include a session management function (SMF) or access and mobility management function (AMF) 106, a policy control function (PCF) 108, a binding support function (BSF) 110, a network or NF repository function (NRF) 112, and an application function (AF) 114.

5G network 104 may include an SMF or AMF 106 (or both), configured to handle session establishment, modification, and release. When a UE 102 connects to the 5G network 104, an SMF or AMF 106 may initiate the session creation. An SMF may include various functionality relating to subscriber sessions, e.g., session establishment, modification, and release. An AMFs primary tasks may include registration management, connection management, reachability management, mobility management, and various function relating to security and access management and authorization.

PCF 108 may be assigned to a subscriber session (e.g., a PDU or UE session) created when a UE 102 registers with the 5G network 104. The PCF 108 may generate policy rules for the session to control quality of service and charging for the session, and may register the session with the BSF 110. The PCF 108 may also register with the NRF 112, and may provide metadata or other information to the NRF 112 identifying capabilities or configuration settings for the PCF 108. A PCF 108 may operate as an individual unit, or as part of a PCF set, where a 5G session may be managed by any available or most convenient PCF from a corresponding PCF set.

BSF 110 may maintain a list, database, or other data structure of binding records describing which PCF 108 is assigned to a subscriber session, or which PCF 108 is assigned to a subscriber registration related association. The BSF 110 may provide the binding support management service (Nbsf_Management service), allowing the BSF to provide 5G session binding functionality, which can ensure that an AF 114 request for a certain session can reach the relevant PCF 108 having the session information. BSF 110 may obtain information about a PCF 108 and its capabilities from the NRF 112, from messages received from the PCF, or a combination thereof. The BSF 110 may create a binding record when a PCF 108 registers a session with BSF 110. AF 114 seeking to discover the session binding for a UE 102 may do so by querying the BSF 110 using a discovery application programming interface (API) provided by the BSF. The BSF 110 may also register with the NRF 112, and may provide metadata or other information to the NRF 112 identifying capabilities or configuration settings for the BSF 110.

The NRF 112 may be a monitoring element which includes and maintains a repository of NF profiles for available NF instances (including BSF 110 and PCF 108). The NF profiles may identify what services or resources each NF provides, and potentially metadata provided by the NF, which may specify vendor-specific features supported by the NF but not included in standard 3GPP specifications. For example, NFs may register with the NRF to provide registration information and metadata for the NF to the NRF 112 for storing in the repository. Once an NF is registered with the NRF, the NRF may provide information for the NF in response to discovery requests. For example, an NF may send a discovery request to the NRF 112 including search criteria, and the NRF may issue a discovery response providing identifying information and metadata for NFs in the repository matching the search criteria. Consumer NFs can subscribe to receive information about producer NF instances that have registered with the NRF 112.

The AF 114 may be configured to manage and provide application services to subscribers and UEs 102. AF 114 may interact with the BSF 110 to determine which PCF 108 is associated with a particular 5G session or with a particular UE (subscriber/SUPI), and the AF 114 may interact with the PCF 108 to manage properties of communication sessions for various resources.

After a binding record becomes inactive or stale, the PCF 108 may send a delete binding record request or other message for deleting the stale binding record from the binding record database of the BSF 110. But in some instances, the BSF 110 may never receive a delete request. For example, some error within the network may result in a deletion request failing to be successfully transmitted or completed, such as if a PCF suffers a critical failure and loses its own record of active 5G session entries, due to lost data packets, or for other reasons. Accordingly, the BSF 110 may have many session binding records pertaining to invalid or stale 5G sessions, inhibiting the performance of the BSF 110 and the 5G network 104. In order to perform session validation operations, the PCF 108, the BSF 110, or both may include a session validation module (SVM) 116. The SVM 116 may include a module configured to perform periodic updates in order to verify the validity of a 5G session, and enable a BSF 110 to determine when it is safe to delete a binding record associated with a stale or invalid session.

The periodic update based session validation operation enables a client system (e.g., PCF 108) to provide a validity time for a session, which a server system (e.g., BSF 110) may accept, and the client or the server periodically, based on this accepted time, either updates the validity of a sessions or checks if the session is still valid. The SVM 116 may perform the periodic update based session validation via the use of vendor specific attributes (e.g., a “revaliationTime” attribute and associated operations) implemented at the PCF 108, the BSF 110, or both. The vendor specific attribute enable the exchange of a revalidation time period, and then the exchange of updates based on that time period to establish whether a session is still valid.

A BSF 110 may publish its ability to support a “revalidationTime” feature in “supportedVendorSpecificFeatures” by registering it with NRF 112 in the BSF's NFProfile. A PCF 108 can determine supported vendorSpecificFeatures of BSF 110 through an NRF discovery exchange, and select a BSF that supports “revalidationTime”. When PCF 108 messages BSF 110 to create or update a binding record for a 5G session, the PCF can provide custom information (for example, as vendor specific extension attributes; see, e.g., TS 29.500 section 6.6.3) to BSF. In this case, the PCF 108 can provide a vendor specific attribute “revalidationTime” along with a time value. The BSF 110 can accept the revalidation time in the vendor specific attribute sent by PCF 108, or the BSF may determine an alternate revalidationTime value. For example, if the duration provided by the PCF 108 is outside of an acceptable duration range set by an operator of the BSF 110, the BSF may select an operator-selected default revalidationTime. Whichever revalidationTime value the BSF 110 selects, it may return that value to the PCF 108 along with the binding record creation response, for example by including a vendor specific attribute with revalidationTime in the response. The PCF 108 may utilize the revalidation time provided by the BSF 110 as the time period within which the PCF 108 should provide an update on the 5G session to the BSF 110.

Accordingly, both the PCF 108 and BSF 110 may monitor a same revalidationTime timer that may count from the point of a binding record creation. If a 5G session is still valid as the expiry of the timer approaches, the PCF 108 may be configured to send an update to the BSF 110, for example by invoking Nbsf_Management_Update. The update may include a new revalidationTime value to apply, or may indicate that the BSF 110 should restart or refresh the previously exchanged revalidationTime value. However, if the revalidation timer expires without receiving an update, the BSF 110 may determine that the 5G session has become stale, and the associated binding record should be deleted.

The BSF 110 may be configured to perform additional checks or safeguards to determine the validity of a 5G session. For example, if no update is received by the expiration of the revalidation timer, the BSF 110 may be configured to reset the timer automatically a selected number of times (e.g., set by an operator), in case an update message from the PCF 108 was lost in transmission. If a successful update is received, the number of errors or missed updates may be reset. After the selected number of consecutive missed updates, however, the BSF 110 may delete the binding record. In some embodiments, the BSF 110 may determine whether an Rx session request has been received for the binding record or the associated 5G session. Rx may include an interface protocol used by, e.g., AFs 114 as part of providing services for a session. For Rx requests, an AF 114 may send the Rx request to the BSF 110. The BSF 110 may look up the binding record to determine a PCF 108 associated with the communication session, and then may act as a proxy or forwarder to automatically forward the Rx message to the appropriate PCF, and in turn may receive the response from the PCF to route to the AF. In this manner, the BSF 110 may be able to determine whether a session is still active based on the communication exchange, and if so, may refresh the last revalidation time exchanged with the PCF 108. Similarly, the PCF 108 may automatically refresh the last exchanged revalidation time when an Rx request is processed. Similarly, any other messaging that passes through the BSF 110 and may indicate that a session is still active, and therefore may update a “last access” timestamp for the 5G session, may also cause the BSF 110 to refresh the timer without deleting the binding record.

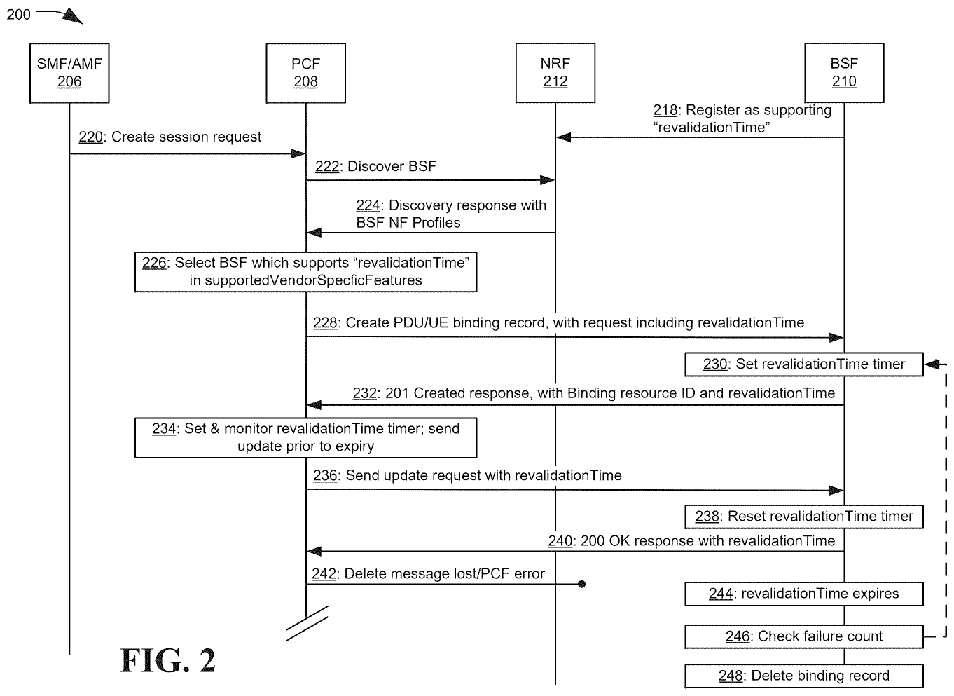

As PCFs 108 may be part of a PCF set, or BSFs 110 may be part of a BSF set, or both, the periodic update operation may be set up between PCF 108 and BSF 110 to support sending or receiving updates to or from other NFs in the corresponding set when the original NF is unavailable. An example process for subscription based 5G session validation is discussed in regard to FIG. 2.

FIG. 2 is a flow diagram of a system 200 configured to implement periodic update based 5G session validation, in accordance with certain embodiments of the present disclosure. In particular, the diagram 200 may depict a process flow within a 5G communication network by which a binding record is created, and then an update schedule is established for notifying whether an associated 5G session is still valid or has become stale. Diagram 200 may depict an example message and processing flow between an SMF/AMF 206, PCF 208, NRF 212, and BSF 210. The components in diagram 200 may correspond to elements described in regard to FIG. 1.

At 218, BSF 210 may register with NRF 212. As part of the registration process, the BSF 210 may specify that it supports the “revalidationTime” custom attribute, by including it within “supportedVendorSpecificFeatures” in the BSF's NFprofile. The NRF 212 may store the NFprofile for BSF 210, so that the BSF 210 and its supported features are discoverable by other NFs within the network.

At 220, a UE may connect to the network, causing SMF/AMF 206 to issue a create session request to PCF 208. The create session request may assign PCF 208 (or an associated PCFset) to manage the PDU session or UE session.

At 222, the PCF 208 may query the NRF 212 to discover a BSF 210 to manage the binding record for the 5G session. In response, at 224, the NRF 212 may provide one or more NF profiles for available BSFs in the network, which may include BSF 210.

At 226, the PCF 208 may select a BSF that supports “revalidationTime” in “supportedVendorSpecificFeatures”, based on the received NF profiles. In particular, the PCF 208 may include vendor specific custom attributes or code that directs the PCF to select BSFs 210 that support “revalidationTime” over BSFs that do not (e.g., in all instances, or for 5G sessions with particular features or attributes).

At 228, the PCF 208 may issue a create PDU/UE binding record request to the selected BSF 210, along with a proposed revalidationTime vendor specific attribute value. The revalidation time value may specify how long the BSF 210 should consider a session valid without receiving an update to refresh the session, and may be provided in a DateTime data format, for example. The binding record request may be issued in the format of: POST “{apiRoot}/nbsf-management/v1/pcfBindings” with RevalidationTime. In the case of a PDU binding record request, the PCF 208 may also provide an IP address, DNN, S-NSSAI, or similar information for use as a key. In the case of the PCF 208 registering with the BSF for a UE, the PCF 208 may send Subscription Permanent Identifier (SUPI) information to the BSF 210 as the binding key for pcfBinding for the session (see, e.g., 3GPP TS 29.521 5.6.2.2 and 5.6.2.10). SUPI may be a unique identifier in 5G allocated to a SIM card of a UE.

In response to the binding record request, BSF 210 may evaluate the revalidation time proposed by the PCF 208, at 230. In some embodiments, the BSF 210 may be configured to adopt the proposed revalidation time automatically. In other embodiments, the BSF 210 may compare the received revalidation time against one or more rules, limits, or adjustments, which may be set by an operator of the BSF 210. For example, the BSF 210 may be configured to reject revalidation times that are too short or too long. In another example, the BSF 210 may be configured to make randomized modifications to the proposed revalidation time, in order to avoid situations where large numbers of updates may be received approximately concurrently and create processing load issues. The BSF 210 may be configured with rules of how to modify the proposed revalidation time, or with one or more default revalidation times to propose as an alternative.

At 232, the BSF 210 may return a “201 Created” response to the PCF 208, along with a binding resource ID and the selected revalidationTime custom parameter value. In the case of a timer value that counts down, the BSF 210 may begin the timer at this point. In examples where the timer is scheduled to expire at a specified date and time, there may be no need to start a timer at a particular point.

At 234, the PCF 208 may receive the binding response, and may set and monitor the revalidationTime timer value received in the response. If the expiry of the revalidation timer is approaching and the corresponding 5G session is still active, the PCF 208 may prepare to send an update to the BSF 210. How soon the PCF 208 is configured to send an update before the timer expires may be set by an operator of the PCF 208, or may be some default value configured to ensure the BSF 210 receives and processes the update before its own monitored revalidation timer expires.

At 236, the PCF 208 may send an update request to the BSF 210 corresponding to the 5G session and its binding record, which request may include a revalidationTime value. The revalidation time may be the same duration as that set by the BSF 210 previously (e.g., at 230 and 232), or may a time generated according to rules set at the PCF 208. The PCF 208 may invoke the Nbsf_Management_Update service operation, for example as an HTTP PATCH request with “revalidationTime” in Vendor Specific Attribute “{apiRoot}/nbsf-management/v1/pcfBindings/{bindingld}”.

At 238, the BSF 210 may receive the update request, and may use (or modify) the received revalidation time from the request, thereby resetting the revalidationTime timer. The BSF 210 may issue a “200 OK” status code response including the selected revalidationTime value, with the message body containing a representation of the updated session binding information in the “PcfBindingPatch” data structure. The PCF 208 may implement the selected revalidationTime based on the response.

At 242, prior to the current revalidation time expiring, the PCF 208 may encounter and error or crash, or the 5G session may end, resulting the PCF 208 sending a delete binding record request that is lost in transmission and does not reach the BSF 210. In either instance, the 5G session may become invalid or stale, and no further updates may be forthcoming from the PCF 208. Accordingly, at the BSF 210, the revalidationTime timer may expire, at 244. In some embodiments, the BSF 210 may maintain a failure count, and may only delete a binding record after a selected number of consecutive failures. At 246, the BSF 210 may check the failure count, and if it's below a threshold, the BSF 210 may reset the revalidation timer, at 230. However, if the failure count has met or exceeded the selected threshold (which may be triggered by a single failure, in some examples), the BSF 210 may determine that the 5G session corresponding to the binding record is invalid, and may delete the binding record, at 248.

As noted above, the binding record creation and update timer exchange can be performed for a PCFset instead of an individual PCF 208. An NFset, of which a PCFset may be a type, may be a group of a same type NFs that can function as backup or redundant modules to service an operation. For example, if the primary PCF 208 servicing a 5G session crashes or becomes unavailable, another PCF in the PCFset may be able to continue servicing the session, including issuing updates based on the revalidationTime timer.

Similarly, BSF 210 may be part of a BSFset. When the BSF 210 creates a binding record, it may be created for a BSFset, so that PCFs (or other NFs) can access any BSF from the BSFset to access the binding record. If the primary BSF 210 goes down, another BSF in the BSFset may take over in monitoring the revalidationTime timer and receiving update notifications or deleting binding records.

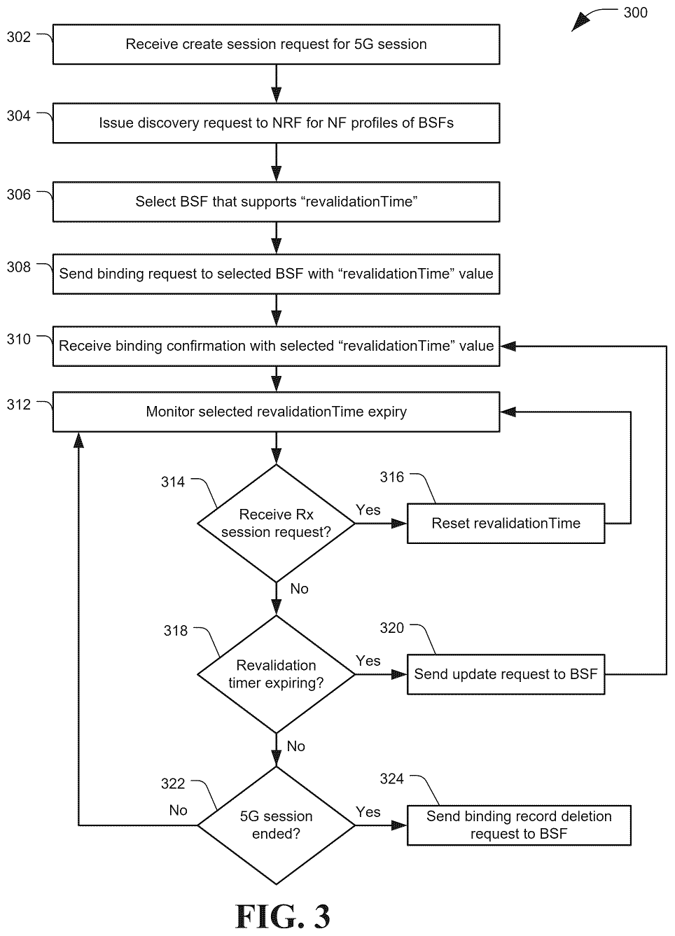

The proposed periodic update based 5G session validation process may allow a PCF 208 to periodically update the session binding in BSF 210, which in turn may allow the BSF 210 to determine whether a 5G session is still valid at a PCF 208. When no update is received within the revalidationTime period, the BSF may determine that the session is no longer valid, and clean up the session or any associated binding records, thereby preventing the BSF from maintaining junk binding records. The proposed solution may be fully compliant with existing 3GPP procedures and open APIs. An example method by which a PCF may validate 5G sessions via updates to a BSF is described in regard to FIG. 3.

FIG. 3 depicts a flowchart 300 of an example method to perform periodic update based 5G session validation, in accordance with certain embodiments of the present disclosure. In particular, flowchart 300 depicts an example process by which a PCF may create a binding record for a 5G session, and manage an update timer to keep a BSF notified regarding session validity. The method of flowchart 300 may be executed by a PCF, such as PCF 108 of FIG. 1 or PCF 208 of FIG. 2.

At 302, the method may include receiving a create session request for a 5G session, such as from an SMF or AMF. In response, the method may include issuing a discovery request to a NRF for NF profiles of BSFs, at 304. At 306, the method may include receiving the BSF NF profiles, and selecting a BSF that supports a “revalidationTime” custom parameter. The method may then include sending a binding request to the selected BSF, with the binding request including a selected “revalidationTime” custom parameter value, at 308.

At 310, the method may include receiving a binding confirmation from the BSF, including a binding ID and a revalidationTime custom parameter value. The revalidationTime value received from the BSF may be the same as the one sent by the PCF, at 308, or it may include a different value. The method may include implementing the revalidationTime value received from the BSF, regardless of whether the value has been changed from the PCF-proposed value.

At 312, the method may include monitoring the revalidationTime timer or expiration limit. While the revalidationTime period is ongoing, the PCF may monitor various factors. At 314, the method may include determining whether an Rx session request has been received, or any other message or event that may update a “last accessed” value for the session or binding record at the BSF. If yes, the method may include resetting or refreshing the “revalidationTime” timer, at 316, for example by a duration or amount as last set in a response from the BSF. After resetting the timer, the method may include continuing the monitor the BSF revalidation timer, at 312.

If an Rx session request has not been received, at 314, the method may include determining whether the revalidationTime period is expiring, at 318. This may include determining when to send an update in sufficient time before the time period expires so that the update can be received and processed at the BSF. If the time period is expiring, the method may include sending a session update request to the BSF, at 320. The request may include a new “revalidationTime” value, either corresponding to a duration as previously set by the BSF, or a different value selected by the BSF. In some examples, the update may direct the BSF to refresh the revalidationTime based on the last-used value, without specifying a new value. After sending the update, the method may include receiving a binding update confirmation from the BSF, at 310, which may include a “revalidationTime” value that both the BSF and PCF will implement.

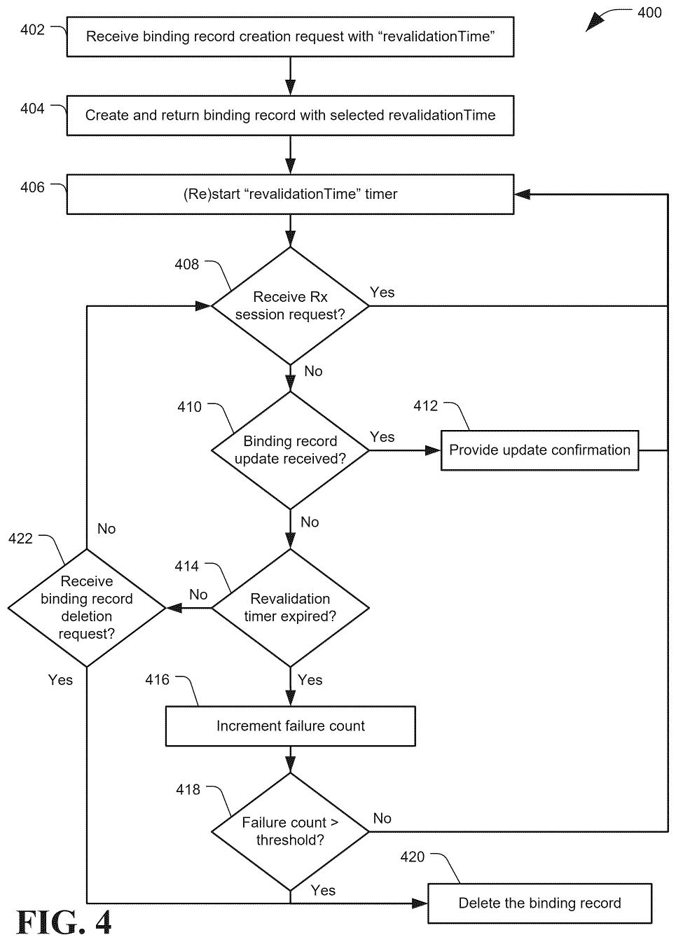

If the revalidationTime period is not expiring, at 318, the method may include determining whether the 5G session has ended or is ending, at 322. If not, the method may include continuing to monitor the revalidation timer, at 312. However, if the 5G session is ending, the method may include sending a session termination request or message to the BSF, at 324. If received without error, the message may cause the BSF to delete the session binding record without waiting for the revalidationTime period to expire. A method for monitoring the validity of a 5G session at the BSF is described in regard to FIG. 4.

FIG. 4 depicts a flowchart 400 of an example method to perform periodic update based 5G session validation, in accordance with certain embodiments of the present disclosure. In particular, flowchart 400 depicts an example process by which a BSF can monitor a revalidation timer, and utilize the timer and session updates to determine whether a 5G session is still valid. The method of flowchart 400 may be executed by a BSF, such as BSF 110 of FIG. 1 or BSF 210 of FIG. 2.

The method may include receiving a binding record creation request associated with a 5G session, along with a “revalidationTime” custom attribute value, at 402. At 404, the method may include creating the binding record, evaluating the revalidationTime value, potentially selecting a different timer value as described herein, and returning a binding record confirmation along with the selected revalidationTime value.

At 406, the method may include starting the revalidationTime timer, or monitoring for when a selected date and time of the revalidationTime attribute has been reached. While monitoring the revalidation timer, the method may include determining whether an Rx session request for the corresponding 5G session has been received, or the “last accessed” timestamp for the binding has otherwise been updated, at 408. As explained herein, the Rx session request may update a “last accessed” timestamp for the binding record, and may indicate that the associated 5G session is still valid. Accordingly, when an Rx session request has been successfully received and processed, the method may include restarting the “revalidationTime” timer, at 406, for example using the duration or value last provided to the PCF (e.g., at 404).

If an Rx session request has not been received, or the “last accessed” timestamp otherwise updated, the method may include determining whether a binding record update request has been received from the PCF, at 410. If so, the method may include confirming the update, and providing a confirmation response, at 412, which may include a “revalidationTime”. For example, if the update request included a revalidationTime value, the BSF may adopt the proposed value or provide a different value in the confirmation response. If the update indicated that the time duration last proposed by the BSF be renewed, the method may include refreshing that value without providing a “revalidationTime” response. Other embodiments are also possible. Once the update confirmation has been provided, the method may include restarting the revalidation timer, at 406.

If an update request has not been received, at 410, the method may include determining whether the revalidation time duration has expired, at 414. If not, the method may include determining whether a binding record deletion request or 5G session termination notification has been received, at 422. If not, the method may include continuing to monitor for Rx session requests, at 408, and update requests, at 410. However, if a session termination request or notification has been received, the method may include deleting the binding record, at 420.

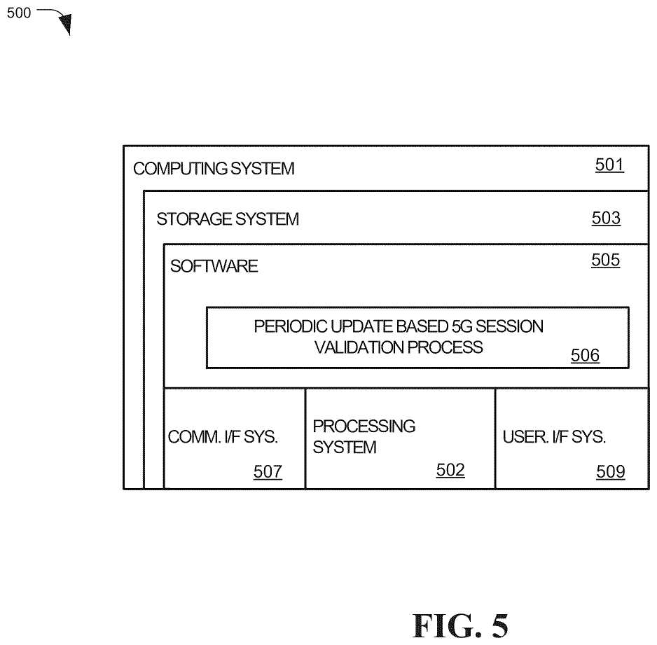

If the revalidation timer has expired, at 414, the method may include updating a failure count, at 416. For example, the BSF may be configured to have a failure or error tolerance of missed updates before deleting a binding record, in case an update message is lost. If so, the method may include determining whether the failure count is above the selected threshold, at 418. If not, the method may include restarting the revalidation timer, at 406, for example with a last-used refresh duration. However, if the failure count has exceeded the threshold, or if the system is configured to delete the binding record after a single failure, the method may include determining that the 5G session is now invalid, and deleting the binding record, at 420. A computing system configured to perform the operations and methods described herein is provided in regard to FIG. 5.

FIG. 5 is a diagram of a system 500 configured to implement periodic update based 5G session validation, in accordance with certain embodiments of the present disclosure. System 500 may be an example of an apparatus including a computing system 501 that is representative of any system or collection of systems in which the various processes, systems, programs, services, and scenarios disclosed herein may be implemented. For example, computing system 501 may be an example user equipment 102, network connectivity components 120, 5G Core network 104, or any of the subcomponents depicted in system 100 of FIG. 1. Examples of computing system 501 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing system 501 may be implemented as a single apparatus, system, or device or may be implemented in a distributed manner as multiple apparatuses, systems, or devices. Computing system 501 may include, but is not limited to, processing system 502, storage system 503, software 505, communication interface system 507, and user interface system 509. Processing system 502 may be operatively coupled with storage system 503, communication interface system 507, and user interface system 509.

Processing system 502 may load and execute software 505 from storage system 503. Software 505 may include and implement periodic update based 5G session validation process 506, which may be representative of any of the operations for creating a session binding at a BSF along with a revalidation timer, and then using the revalidation timer to verify the validity of a 5G communication session at the BSF, as discussed with respect to the preceding figures. When executed by processing system 502, software 505 may direct processing system 502 to operate as described herein for at least the various processes, operational scenarios, and sequences discussed in the foregoing implementations. Computing system 501 may optionally include additional devices, features, or functionality not discussed for purposes of brevity.

In some embodiments, processing system 502 may comprise a micro-processor and other circuitry that retrieves and executes software 505 from storage system 503. Processing system 502 may be implemented within a single processing device but may also be distributed across multiple processing devices or sub-systems that cooperate in executing program instructions. Examples of processing system 502 may include general purpose central processing units, graphical processing units, application specific processors, and logic devices, as well as any other type of processing device, combinations, or variations thereof.

Storage system 503 may comprise any memory device or computer readable storage media readable by processing system 502 and capable of storing software 505. Storage system 503 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 503 may also include computer readable communication media over which at least some of software 505 may be communicated internally or externally. Storage system 503 may be implemented as a single storage device but may also be implemented across multiple storage devices or sub-systems co-located or distributed relative to each other. Storage system 503 may comprise additional elements, such as a controller, capable of communicating with processing system 502 or possibly other systems.

Software 505 (including periodic update based 5G session validation process 506 among other functions) may be implemented in program instructions that may, when executed by processing system 502, direct processing system 502 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 505 may include additional processes, programs, or components, such as operating system software, virtualization software, or other application software. Software 505 may also comprise firmware or some other form of machine-readable processing instructions executable by processing system 502.

In general, software 505 may, when loaded into processing system 502 and executed, transform a suitable apparatus, system, or device (of which computing system 501 is representative) overall from a general-purpose computing system into a special-purpose computing system as described herein. Indeed, encoding software 505 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage, as well as other factors.

For example, if the computer readable storage media are implemented as semiconductor-based memory, software 505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 507 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable storage medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A Policy Control Function (PCF) system, comprising:
one or more processors; and
a memory having stored thereon instructions that, upon execution by the one or more processors, cause the one or more processors to:
send a binding record request to a Binding Support Function (BSF) for a 5G communication session associated with the PCF;
receive a binding record confirmation with a selected revalidation time value that indicates when the 5G communication session will be considered invalid and a binding record associated with the 5G communication session will be deleted; and
prior to an expiration of the selected revalidation time value, send a binding record update request to the BSF to refresh the selected revalidation time value.

2. The PCF system of claim 1, wherein the instructions comprise further instructions that, upon execution by the one or more processors, cause the one or more processors to:
issue a discovery request to a network repository function (NRF) to discover one or more BSFs able to manage the binding record for the 5G communication session;
receive one or more profiles associated with the one or more BSFs; and
select the BSF to send the binding record request based on a profile for the BSF indicating support for a revalidation time custom feature.

3. The PCF system of claim 2, wherein the instructions comprise further instructions that, upon execution by the one or more processors, cause the one or more processors to:
include a proposed revalidation time value with the binding record request;
determine whether the selected revalidation time value received from the BSF matches the proposed revalidation time value; and
implement the selected revalidation time value when the proposed revalidation time value and the selected revalidation time value do not match.

4. The PCF system of claim 3, wherein the instructions comprise further instructions that, upon execution by the one or more processors, cause the one or more processors to:
send the binding record update request to indicate to the BSF to refresh the selected revalidation time value from the binding record confirmation; and
refresh the selected revalidation time value at the PCF to determine when to send a next binding record update request.

5. The PCF system of claim 3, wherein the instructions comprise further instructions that, upon execution by the one or more processors, cause the one or more processors to:
include a refresh revalidation time in the binding record update request, the refresh revalidation time suggesting a new revalidation time value.

6. The PCF system of claim 5, wherein the instructions comprise further instructions that, upon execution by the one or more processors, cause the one or more processors to:
receive a binding record update confirmation in response to the binding record update request, the binding record update confirmation including a selected refresh revalidation time;
determine whether the selected refresh revalidation time received matches the new revalidation time value; and
implement the selected refresh revalidation time when the new revalidation time value and the selected refresh revalidation time do not match.

7. The PCF system of claim 6, wherein the instructions comprise further instructions that, upon execution by the one or more processors, cause the one or more processors to:
determine when the 5G communication session is ended; and
send a session termination message to the BSF based on the determination prior to expiration of a current revalidation time period.

8. The PCF system of claim 7, wherein the instructions comprise further instructions that, upon execution by the one or more processors, cause the one or more processors to:
receive an Rx protocol message associated with the 5G communication session and routed through the BSF; and
reset the selected revalidation time value based on receiving the Rx protocol message.

9. The PCF system of claim 8, wherein the 5G communication session comprises a packet data unit (PDU) session.

10. The PCF system of claim 8, wherein the 5G communication session comprises a user equipment (UE) session.

11. A method comprising:
operating a Policy Control Function (PCF) of a mobile network, including:
sending a binding record request to a Binding Support Function (BSF) for a 5G communication session associated with the PCF;
receiving a binding record confirmation with a selected revalidation time value that indicates when the 5G communication session will be considered invalid and a binding record associated with the 5G communication session will be deleted; and
prior to an expiration of the selected revalidation time value, sending a binding record update request to the BSF to refresh the selected revalidation time value.

12. The method of claim 11, further comprising:
issuing a discovery request to a network repository function (NRF) to discover one or more BSFs able to manage the binding record for the 5G communication session;
receiving one or more profiles associated with the one or more BSFs; and
selecting the BSF to send the binding record request based on a profile for the BSF indicating support for a revalidation time custom feature.

13. The method of claim 11, further comprising:
including a proposed revalidation time value with the binding record request;
determining whether the selected revalidation time value received from the BSF matches the proposed revalidation time value; and
implementing the selected revalidation time value when the proposed revalidation time value and the selected revalidation time value do not match.

14. The method of claim 11, further comprising:
sending the binding record update request to indicate to the BSF to refresh the selected revalidation time value from the binding record confirmation; and
refreshing the selected revalidation time value at the PCF to determine when to send a next binding record update request.

15. The method of claim 11, further comprising:
including a refresh revalidation time in the binding record update request, the refresh revalidation time suggesting a new revalidation time value.

16. The method of claim 15, further comprising:
receiving a binding record update confirmation in response to the binding record update request, the binding record update confirmation including a selected refresh revalidation time;
determining whether the selected refresh revalidation time received matches the new revalidation time value; and
implementing the selected refresh revalidation time when the new revalidation time value and the selected refresh revalidation time do not match.

17. The method of claim 11, further comprising:
determining when the 5G communication session is ended; and
sending a session termination message to the BSF based on the determination prior to expiration of a current revalidation time period.

18. The method of claim 11, further comprising:
receiving an Rx protocol message associated with the 5G communication session and routed through the BSF; and
resetting the selected revalidation time value based on receiving the Rx protocol message.

19. The method of claim 11, wherein the 5G communication session comprises a packet data unit (PDU) session.

20. The method of claim 11, wherein the 5G communication session comprises a user equipment (UE) session.
